(19) United States
(12) Patent Application Publication
(10) Pub. No.: US 2005/0274735 A1
(43) Pub. Date: Dec. 15, 2005

(54) Inverted bottle support and dispensing apparatus

(76) Inventors: Madhukant C. Patel, Arlington, VA (US); Bharati Patel, Arlington, VA (US)

Correspondence Address: S. Michael Bender, P.O. Box 530-399, St. Petersburg, FL, 33747, US

(21) Appl. No.: 11/149,661

(22) Filed: Jun. 10, 2005

Related U.S. Application Data
(60) Provisional application No. 60/579,104, filed on Jun. 14, 2004.

(51) Int. Cl. B67D 5/00

(52) U.S. Cl. 222/83.5

(57) ABSTRACT

With a first class of an inverted bottle support and dispenser apparatuses, an apparatus includes vertical surface mounting means, inverted bottle support bracket means, and bottle-bracket-to-surface-mount connection means connected between the inverted bottle support bracket means and the vertical surface mounting means. An inverted bottle is supported by the inverted bottle support bracket means. Manually-operated dispenser assembly means are connected to the inverted bottle. With a second class of apparatuses of the invention, an apparatus includes a combination dispensing valve and vent tube unit for connecting to a bottle and a combination support unit for supporting an inverted combination dispensing valve and vent tube unit. Preferably, the combination support unit includes a top bracket portion for receiving the combination dispensing valve and vent tube unit, a riser bracket portion connected to the top bracket portion and descending downward therefrom, and a bottom bracket portion connected to a bottom end of the riser bracket portion.

### CROSS-REFERENCE TO RELATED APPLICATION

This application claims priority based upon my copending Provisional Application Ser. No. 60/579,104; filed Jun. 14, 2004.

### BACKGROUND OF THE INVENTION

1. Field of the Invention

The present invention relates generally to dispensers, and, more particularly, to dispensers adapted for receiving inverted bottles for dispensing the contents therein, especially for bottles that contain liquids.

2. Description of the Prior Art

A bottle that retains a liquid generally has a pour spout at the top of the bottle, and the contents are dispensed from the bottle when the bottle is tilted. To assure maximum dispensing from such a bottle, the bottle is inverted. To avoid the necessity of a user having to tilt or invert a bottle each time it is desired to dispense liquid from the bottle, throughout the years, a number of innovations have been developed relating to retaining a bottle in an inverted orientation and providing a valve for dispensing liquid from the inverted bottle. The following U.S. patents are representative of some of those innovations: U.S. Pat. Nos. 5,405,058, 6,161,726, 6,502,725, and 6,527,145

More specifically, U.S. Pat. No. 5,405,058 discloses a device for dispensing liquids from an inverted bottle. The device includes a bottle-reception housing which includes a valve and a vent tube. The vent tube is provided with a one-way check valve that includes a plurality of O-rings for sealing and that does not appear to be easily disassembled for cleaning. For purposes of simplicity and sanitation, it would be desirable if a device for dispensing liquids from an inverted bottle were provided that included a one-way check valve that does not include a plurality of O-rings for sealing and is easily disassembled for cleaning.

U.S. Pat. No. 6,161,726 discloses a device for dispensing liquids from an inverted bottle in which positive air pressure is introduced into the inverted bottle for forcing liquid out from the bottle by the air pressure. That is, dispensing from the bottle does not occur simply by the force of gravity. The device includes a complex spring, plunger, and diaphragm arrangement to generate the positive air pressure inside the bottle. For purposes of simplicity and ease of manufacture, it would be desirable if a device for dispensing liquids from an inverted bottle permitted the liquid to be dispensed simply by the force of gravity without providing a positive air pressure to the inside of the inverted bottle.

U.S. Pat. No. 6,502,725 discloses a device for dispensing liquids from an inverted bottle which includes an expandable bladder that is attached to a vent tube. The expandable bladder is a component that has a large surface area and requires a lot of attention for cleaning. In this respect, it would be desirable if a device for dispensing liquids from an inverted bottle were provided which does not include an expandable bladder attached to a vent tube.

U.S. Pat. No. 6,527,145 discloses a device for dispensing liquids from an inverted bottle in which admission of replacement air through a vent tube into the inverted bottle is through valve which controls air admitted to the vent tube. The valve also controls flow of liquid out from the inverted bottle. To avoid the complexity of a valve which controls both replacement air through a vent tube and liquid dispensed from an inverted bottle, it would be desirable if a device for dispensing liquids from an inverted bottle were provided that does not require a single valve assembly to control both replacement air through a vent tube and liquid dispensed from the inverted bottle.

U.S. Pat. No. 4,921,138 may be of interest for its disclosure of a device for administration of enteral fluids from pre-filled, shape-retentive containers.

Still other features would be desirable in an inverted bottle support and dispenser apparatus. For example, at certain times it may be desirable to support a device for dispensing liquids from an inverted bottle on a vertically oriented support structure, such as a wall. At other times it may be desirable to support a device for dispensing liquids from an inverted bottle on a horizontally oriented support structure, such as a table top, desk top, or counter top. In this respect, for purposes of simplicity and efficiency, it would be desirable to provide a single device for dispensing liquids from an inverted bottle that can be optionally supported by either a vertically oriented support structure or a horizontally oriented support structure.

At certain times it may be desired to support a single inverted bottle by a single device for dispensing liquids from the single inverted bottle. However, at other times, because dispensed liquids, such as beverages, come in many flavors, carbonated or non-carbonated, with sugar or without sugar, with caffeine or without caffeine, among other various optional characteristics, it may be desirable to provide a plurality of beverages at a common location. That is, it would be desirable to provide a device for dispensing liquids from an inverted bottle that is modular in nature and that can be combined with other such modular devices to provide a combination of a plurality of modular devices for dispensing liquids from a plurality of inverted bottles.

Each modular device for dispensing liquids from an inverted bottle would have a number of components. For purposes of simplicity and efficiency, it would be desirable if such components of the modular devices would be interchangeable.

Another desirable feature for a dispensing device for an inverted bottle is to permit easy disassembly, easy cleaning, and easy reassembly of both a vent tube air valve assembly and a valve assembly for liquid flow control.

Thus, while the foregoing body of prior art indicates it to be well known to use a dispensing device for an inverted bottle containing a liquid, the prior art described above does not teach or suggest an inverted bottle support and dispenser apparatus which has the following combination of desirable features: (1) includes a one-way check valve that does not include a plurality of O-rings for sealing and is easily disassembled for cleaning; (2) permits the liquid to be dispensed simply by the force of gravity without providing a positive air pressure to the inside of the inverted bottle; (3) does not include an expandable bladder attached to a vent tube; (4) does not require a single valve assembly to control both replacement air through a vent tube and liquid dispensed from the inverted bottle; (5) provides a single device for dispensing liquids from an inverted bottle that can be optionally supported by either a vertically oriented support structure or a horizontally oriented support structure; (6) is modular in nature and that can be combined with other such modular devices to provide a combination of a plurality of modular devices for dispensing liquids from a plurality of inverted bottles; (7) provides interchangeable components for the modular devices; and (8) permits easy disassembly, easy cleaning, and easy reassembly of both a vent tube air valve assembly and a valve assembly for liquid flow control. The foregoing desired characteristics are provided by the unique inverted bottle support and dispenser apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides, with a first class of an inverted bottle support and dispenser apparatuses, an apparatus includes vertical surface mounting means, inverted bottle support bracket means, and bottle-bracket-to-surface-mount connection means connected between the inverted bottle support bracket means and the vertical surface mounting means. An inverted bottle is supported by the inverted bottle support bracket means. Manually-operated dispenser assembly means are connected to the inverted bottle.

With one embodiment, the embodiment can be mounted on a wall, and the vertical surface mounting means include a top mounting strip which includes a plurality of hook-receiver, outward-extending regions and a plurality of inward-extending, vertical-surface-contacting regions interspersed between the hook-receiver, outward-extending regions.

The vertical surface mounting means further include a bottom mounting strip which includes a plurality of hook-receiver, outward-extending regions and a plurality of inward-extending, vertical-surface-contacting regions interspersed between the hook-receiver, outward-extending regions. The respective hook-receiver, outward-extending regions and respective inward-extending, vertical-surface-contacting regions of the top mounting strip and the bottom mounting strip are placed in registration when the top mounting strip and the bottom mounting strip are mounted on a vertical surface.

The inverted bottle support bracket means include a top bracket portion for engaging a bottom portion of the inverted bottle. A bottom bracket portion is provided for supporting a top portion of the inverted bottle, and an interconnector bracket strut portion is connected between the top bracket portion and the bottom bracket portion.

The top bracket portion includes a forward projecting top strut which is connected to the interconnector bracket strut portion. A cup-supporting bolt is connected to a distal end of the forward projecting top strut, and an inverted cup member is connected to the cup-supporting bolt. The inverted cup member includes an adjustment slot in which a bottom end of the cup-supporting bolt rides.

The bottom bracket portion includes a forward projecting bottom strut which is connected to the interconnector bracket strut portion, and a bottle-neck-reception notch is located at a distal end of the forward projecting bottom strut. The bottle-neck-reception notch is C-shaped.

The bottle-bracket-to-surface-mount connection means include a top hook portion that is connected to a top portion of the interconnector bracket strut portion and a bottom hook portion that is connected to a bottom portion of the interconnector bracket strut portion.

The manually-operated dispenser assembly means include a manually-operated dispenser assembly which includes a housing portion which includes internal threads for engaging external threads of the inverted bottle. A fluid flow passage in the housing portion is fluid communication with the interior of the inverted bottle. The fluid flow passage includes a fluid exit port. A valve member in the internal flow passage between the inverted bottle and the fluid exit port. A vent tube is supported by the housing portion and extends upward into the inverted bottle. Manually-operated valve control means are connected to the valve member for controlling the valve member. The vent tube can include a ball valve.

The manually-operated valve control means include a valve control rod which is connected to the valve member. A valve handle is connected to the valve control rod for controlling the valve control rod and the valve member.

If desired, a receiver holder unit can be employed, and the receiver holder unit is attachable to a vertically oriented surface. The receiver holder unit includes a tray portion which includes a plurality of receiver-reception positions. The receiver-reception positions are placed in registration with the inverted bottles.

The tray portion includes vertical surface attachment tabs extending outward from edge portions of the tray portion, and the vertical surface attachment tabs include fastener-reception channels. The fastener-reception channels include relatively large fastener reception regions and relatively small fastener reception regions which are adjacent to the relatively large fastener reception regions.

A bracket lock assembly can be connected to the inverted bottle support bracket means.

With another embodiment, the embodiment can be mounted on an 10 automobile window. In this respect, the bottle-bracket-to-surface-mount connection means include a bottom suction cup portion that is connected to a bottom portion of the interconnector bracket strut portion. Also, a receiver holder unit is connected to a distal bottom portion of an interconnector bracket strut portion of the inverted bottle support bracket means.

With another embodiment, a free-standing, rack assembly is provided which includes a vertically oriented bracket support unit. Unit support means are connected to the vertically oriented bracket support unit, for supporting the vertically oriented bracket support unit in the vertical orientation.

More specifically, the vertically oriented bracket support unit includes a plurality vertically oriented bracket support struts arranged in a circular arrangement, and the unit support means include a plurality of support legs arranged in a circular arrangement around the vertically oriented bracket support struts.

Each of the vertically oriented bracket support struts includes a top hook reception aperture and a bottom hook reception aperture. A tray can be placed under the support legs. The tray can be a drip tray.

With a second class of an inverted bottle support and dispenser apparatuses of the invention, an apparatus includes a combination dispensing valve and vent tube unit for connecting to a bottle and a combination support unit for supporting the combination dispensing valve and vent tube unit. Preferably, the combination support unit includes a top bracket portion for receiving the combination dispensing valve and vent tube unit, a riser bracket portion connected to the top bracket portion and descending downward therefrom, and a bottom bracket portion connected to a bottom end of the riser bracket portion. Preferably, the bottom bracket portion includes a receiver-reception position, and a drip screen is received in the receiver-reception position.

In addition, the riser bracket portion includes fastener-reception channels. When fasteners are inserted into the fastener-reception channels, the apparatus can be attached to a vertically oriented wall surface.

Preferably, the combination dispensing valve and vent tube unit includes a valve body which includes a support-unit-engagement portion for engaging the combination support unit, a bottle-reception inlet portion, a vent-tube-reception channel, a valve seat portion, a spout portion, and a valve-assembly-reception channel. A vent tube assembly is received in the vent-tube-reception channel. The combination dispensing valve and vent tube unit also includes a valve assembly, a portion of which is received in the valve-assembly-reception channel for retention inside the valve body. A valve cap is provided for retaining a portion of the valve assembly in the valve body and for permitting easy removal of the valve assembly from the valve body.

Preferably, the valve assembly includes a valve and actuator member which includes a valve portion and an actuator portion connected to the valve portion. A valve operation handle is connected to the actuator portion, and a sealing member is connected to the valve and actuator member for sealing the valve and actuator member with respect to the valve body. A bias spring is located between the valve portion and the valve cap for urging a distal end of the valve portion against the valve seat portion for retaining the valve portion in a closed position.

Preferably, the valve operation handle includes a valve cap contacting end, and the valve cap contacting end is round. Preferably, the valve and actuator member and the sealing member are provided as a unified, integrated structure. Preferably, the valve operation handle is connected to the actuator portion by means of a pivoted handle-to-actuator connection.

Preferably, the vent tube assembly includes a vent tube received in the vent-tube-reception channel, and a vent tube air valve assembly is connected to a distal end of the vent tube. Preferably, the vent tube air valve assembly includes an air valve housing which includes one or more vent holes. A sealing ring removably fixed onto the vent tube between the vent tube and the air valve housing, and a one-way valve element is connected to the air valve housing for covering the one or more vent holes.

Preferably, the riser bracket portion includes riser first side connectors located on one side of the riser bracket portion and complementary riser second side connectors located on an opposite side of the riser bracket portion. The riser first side connectors of one riser bracket portion engage with the complementary riser second side connectors of an adjacent riser bracket portion when a plurality of apparatuses are used together. The riser first side connectors can be resilient female-like members, and the riser second side connectors can be complementary male-like members.

Also, the top bracket portion includes top-to-riser connectors, and the riser bracket portion includes riser-to-top connectors and riser-to-bottom connectors. The riser-to-top connectors engage the top-to-riser connectors, and the bottom bracket portion includes bottom-to-riser connectors which engage the riser-to-bottom connectors.

The support-unit-engagement portion includes inner wall portions and outer flange portions. The inner wall portions includes opposed flat inner wall portions and opposed round inner wall portions. The top bracket portion includes opposed flat inner wall portions and a round inner wall portion. The opposed flat inner wall portions of the top bracket portion are separated from each other by a first separation distance, and the round inner wall portion has an internal diameter which is greater than the first separation distance. The opposed round inner wall portions are separated from each other by a second separation distance which is greater than the first separation distance. The internal diameter of the round inner wall portion and the second separation distance of the opposed round inner wall portions are substantially equal.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a number of preferred embodiments of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved inverted bottle support and dispenser apparatus which has all of the advantages of the prior art and none of the disadvantages.

It is another object of the present invention to provide a new and improved inverted bottle support and dispenser apparatus which may be easily and efficiently manufactured and marketed.

It is a further object of the present invention to provide a new and improved inverted bottle support and dispenser apparatus which is of durable and reliable construction.

An even further object of the present invention is to provide a new and improved inverted bottle support and dispenser apparatus which is susceptible of a low cost of manufacture with regard to both materials and labor, and which accordingly is then susceptible of low prices of sale to the consuming public, thereby making such inverted bottle support and dispenser apparatus available to the buying public.

Still yet a further object of the present invention is to provide a new and improved inverted bottle support and dispenser apparatus which includes a one-way check valve that does not include a plurality of O-rings for sealing and is easily disassembled for cleaning.

Still another object of the present invention is to provide a new and improved inverted bottle support and dispenser apparatus that permits the liquid to be dispensed simply by the force of gravity without providing a positive air pressure to the inside of the inverted bottle.

Yet another object of the present invention is to provide a new and improved inverted bottle support and dispenser apparatus which does not include an expandable bladder attached to a vent tube.

Even another object of the present invention is to provide a new and improved inverted bottle support and dispenser apparatus that does not require a single valve assembly to control both replacement air through a vent tube and liquid dispensed from the inverted bottle.

Still a further object of the present invention is to provide a new and improved inverted bottle support and dispenser apparatus which provides a single device for dispensing liquids from an inverted bottle that can be optionally supported by either a vertically oriented support structure or a horizontally oriented support structure.

Yet another object of the present invention is to provide a new and improved inverted bottle support and dispenser apparatus that is modular in nature and that can be combined with other such modular devices to provide a combination of a plurality of modular devices for dispensing liquids from a plurality of inverted bottles.

Still another object of the present invention is to provide a new and improved inverted bottle support and dispenser apparatus which provides interchangeable components for the modular devices.

Still a further object of the present invention is to provide a new and improved inverted bottle support and dispenser apparatus which permits easy disassembly, easy cleaning, and easy reassembly of both a vent tube air valve assembly and a valve assembly for liquid flow control.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a front view showing a first embodiment of the inverted bottle support and dispenser apparatus of the invention.

FIG. 2 is a top view of the embodiment of the inverted bottle support and dispenser apparatus shown in FIG. 1 taken along line 2-2 of FIG. 1.

FIG. 3 is a side view of the embodiment of the inverted bottle support and dispenser apparatus shown in FIG. 1 taken along line 3-3 of FIG. 1.

FIG. 4 is an enlarged front view of the portion of the embodiment of the invention shown in FIG. 1 that is contained in circled region 4 of FIG. 1.

FIG. 5 is an enlarged side view of the portion of the embodiment of the invention shown in FIG. 3 that is contained in circled region 5 of FIG. 3.

FIG. 6 is an enlarged side view of the portion of the embodiment of the invention shown in FIG. 3 that is contained in circled region 6 of FIG. 3.

FIG. 7 is an enlarged cross-sectional view of the portion of the embodiment of the invention shown in FIG. 1 that is taken along line 7-7 thereof.

FIG. 8 is a front view of a second embodiment of the invention, for use on an automobile window.

FIG. 9 is a side view of the embodiment of the invention shown in FIG. 8, taken along line 9-9 thereof, installed on an automobile window.

FIG. 10 is a top view of a third embodiment of the invention which is a free-standing, self-supported rack, supported on a table top or other horizontal surface, wherein the rack supports three inverted bottles.

FIG. 11 is a side view of the embodiment of the invention shown in FIG. 10, taken along line 111-11 thereof, with the inverted bottles removed therefrom.

FIG. 12 is a top view of a fourth embodiment of the invention which includes five modular devices of the invention mounted on a vertical wall, in use with three inverted bottles.

FIG. 13 is a front view of the embodiment of the invention shown in FIG. 12, taken along line 13-13 thereof.

FIG. 14 is a bottom view of the embodiment of the invention shown in FIG. 13, taken along line 14-14 thereof.

FIG. 15 is a top view of a fifth embodiment of the invention which includes three modular devices of the invention supported by a horizontal surface, in use with three inverted bottles.

FIG. 16 is a front view of the embodiment of the invention shown in FIG. 15, taken along line 16-16 thereof.

FIG. 17 is a side view of the embodiment of the invention shown in FIG. 16, taken along line 17-17 thereof.

FIG. 18 is a bottom view of the embodiment of the invention shown in FIG. 17, taken along line 18-18 thereof.

FIG. 19 is a partial cross-sectional view of a sixth embodiment of the invention which includes a single modular device of the invention supported by a horizontal surface, in use with one inverted bottle.

FIG. 19A is an enlarged cross-sectional view of the portion of the embodiment shown in FIG. 19, contained in circled region 19A thereof.

FIG. 19B is a side view showing a portion of the embodiment of the invention shown in FIG. 19 about to be lowered into an upright-standing bottle.

FIG. 19C is a side view of the portion of the embodiment of the invention shown in FIG. 19B being screwed into the upright-standing bottle shown in FIG. 19B by a person.

FIG. 19D is a side view of the portion of the embodiment of the invention shown in FIGS. 19A to 19C about to be installed on another portion of the embodiment of the invention shown in FIG. 19.

FIG. 19E is an exploded, enlarged side view of the portion of the embodiment of the invention shown in FIG. 19B, contained in circled area 19E thereof.

FIG. 19F is an exploded, enlarged side view of the portion of the embodiment of the invention shown in FIG. 19A, contained in circled area 19F thereof.

FIG. 19G is an enlarged assembly view of a portion of the embodiment of the invention shown in FIG. 19, comprising the distal upper end of the vent tube and the vent tube air valve assembly thereon, contained within the circle 19G of FIG. 19.

FIG. 20 is a top view of the sixth embodiment of the invention, shown in FIG. 19, which includes a single modular device of the invention supported by a horizontal surface, in use with one inverted bottle.

FIG. 21 is an enlarged side view of the embodiment of the invention shown in FIG. 20, taken along line 21-21 thereof.

FIG. 22 is a side view of the embodiment of the invention shown in FIG. 21, taken along line 22-22 thereof.

FIG. 23 is a side view of the embodiment of the invention shown in FIG. 22, taken along line 23-23 thereof.

FIG. 24 is a bottom view of the embodiment of the invention shown in FIG. 23, taken along line 24-24 thereof and rotated 90 degrees.

FIG. 25 is a perspective view of the embodiment of the invention in FIGS. 19 and 20, with the inverted bottle and the valve assembly connected thereto removed.

FIG. 25A is an enlarged cross-sectional side view of the portion of the embodiment of the invention shown in FIG. 25, wherein two components of the modular embodiment are connected together.

FIG. 25B is an exploded cross-sectional side view of the portion of the embodiment of the invention shown in FIG. 25A, wherein the two components of the modular embodiment are not yet connected together.

FIG. 26 is a perspective view of the embodiment of the invention shown in FIG. 25, wherein two components of the modular embodiment are not yet connected together, such as shown also in FIG. 25B.

FIG. 27 is an upside down perspective view of the embodiment of the invention shown in FIG. 25.

FIG. 28 is an upside down perspective view of the partially exploded embodiment of the invention shown in FIG. 27.

FIG. 29 is an enlarged, partially exploded, perspective view of the embodiment of the invention shown in FIG. 25.

FIG. 30 is a perspective view of a fully assembled embodiment of the invention shown in FIG. 29, wherein FIG. 30 corresponds substantially to FIG. 25.

FIG. 31 is a top view of the embodiment of the invention shown in FIG. 19D, taken along line 31-31, wherein an inverted bottle, having a valve assembly attached thereto, is about to be installed on a support member for the inverted bottle.

FIG. 32 is a top view of embodiment of the invention shown in FIG. 31, wherein the inverted bottle, having a valve assembly attached thereto, has been initially installed on the support member for the inverted bottle without locking the valve assembly to the support member.

FIG. 33 is a top view of the embodiment of the invention shown in FIG. 32, wherein the inverted bottle, having a valve assembly attached thereto, has been rotated to lock the valve assembly to the support member.

FIG. 34 is an enlarged front view of the portion of the embodiment of the invention shown in FIG. 33, taken along line 34-34 thereof.

FIG. 34A is an enlarged front view of the portion of the embodiment of the invention shown in FIG. 33, taken along line 34-34 thereof.

FIG. 34A is an enlarged front view of a portion of the embodiment of the invention shown in FIG. 12, showing two adjacent riser bracket portions prior to being mated together.

FIG. 34B is an enlarged front view of two adjacent riser bracket portions of FIG. 34A after being mated together.

FIG. 34C is an enlarged fragmentary portion of FIG. 34B taken along line 34C thereof.

FIG. 34D is an enlarged fragmentary portion of FIG. 34B taken along line 34D thereof.

FIG. 35 is a perspective view of another embodiment of the invention wherein a riser bracket portion includes a reinforcement rib extending from the top to the bottom of the riser bracket portion.

FIG. 36 is an enlarged perspective view of a portion of the embodiment of the invention shown in FIG. 35 that is contained in circled area 36 of FIG. 35.

### DESCRIPTION OF THE PREFERRED EMBODIMENT

With reference to the drawings, a new and improved inverted bottle support and dispenser apparatus embodying the principles and concepts of the present invention will be described.

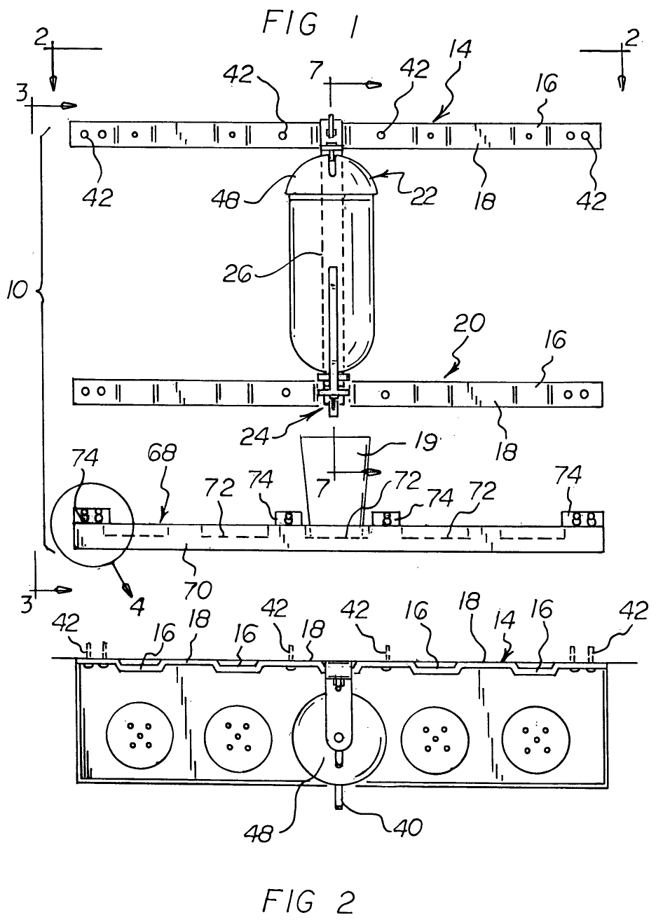

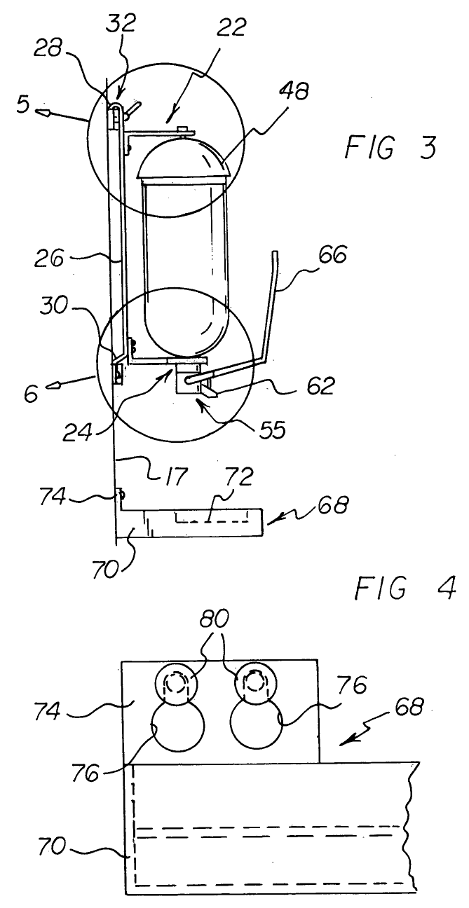

Turning to FIGS. 1-7, there is shown a first embodiment of a first class an inverted bottle support and dispenser apparatus of the invention generally designated by reference numeral 10. In the first embodiment of the first class, an inverted bottle support and dispenser apparatus 10 includes vertical surface mounting means, inverted bottle support bracket means, and bottle-bracket-to-surface-mount connection means connected between the inverted bottle support bracket means and the vertical surface mounting means. An inverted bottle 12 is supported by the inverted bottle support bracket means. Manually-operated dispenser assembly means are connected to the inverted bottle 12.

In accordance with the first embodiment of the invention shown in FIGS. 1-7, the vertical surface mounting means include a top mounting strip 14 which includes a plurality of hook-receiver, outward-extending regions 16 and a plurality of inward-extending, vertical-surface-contacting regions 18 interspersed between the hook-receiver, outward-extending regions 16.

The vertical surface mounting means further include a bottom mounting strip 20 which includes a plurality of hook-receiver, outward-extending regions 16 and a plurality of inward-extending, vertical-surface-contacting regions 18 interspersed between the hook-receiver, outward-extending regions 16. The respective hook-receiver, outward-extending regions 16 and respective inward-extending, vertical-surface-contacting regions 18 of the top mounting strip 14 and the bottom mounting strip 20 are placed in registration when the top mounting strip 14 and the bottom mounting strip 20 are mounted on a vertical surface.

Each of the top mounting strip 14 and the bottom mounting strip 20 can includes plural, e.g. five, hook-receiver, outward-extending regions 16 so that plural, e.g. five, inverted bottles 12 can be supported simultaneously. The inward-extending, vertical-surface-contacting regions 18 are connected to a vertical surface, such as a wall, by using fasteners, such as screws 42.

The inverted bottle support bracket means include a top bracket portion 22 for engaging a bottom portion of the inverted bottle 12. A bottom bracket portion 24 is provided for supporting a top portion of the inverted bottle 12, and an interconnector bracket strut portion 26 is connected between the top bracket portion 22 and the bottom bracket portion 24.

The top bracket portion 22 includes a forward projecting top strut 44 which is connected to the interconnector bracket strut portion 26. A cup-supporting bolt 46 is connected to a distal end of the forward projecting top strut 44, and an inverted cup member 48 is connected to the cup-supporting bolt 46. The inverted cup member 48 includes an adjustment slot 50 in which a bottom end of the cup-supporting bolt 46 rides.

The bottom bracket portion 24 includes a forward projecting bottom strut 52 which is connected to the interconnector bracket strut portion 26, and a bottle-neck-reception notch 54 is located at a distal end of the forward projecting bottom strut 52. The bottle-neck-reception notch 54 is C-shaped.

The bottle-bracket-to-surface-mount connection means include a top hook portion 28 that is connected to a top portion of the interconnector bracket strut portion 26 and a bottom hook portion 30 that is connected to a bottom portion of the interconnector bracket strut portion 26.

The manually-operated dispenser assembly means include a manually-operated dispenser assembly 55 which includes a housing portion 56 which includes internal threads for engaging external threads of the inverted bottle 12. A fluid flow passage 58 in the housing portion 56 is fluid communication with the interior of the inverted bottle 12. The fluid flow passage 58 includes a fluid exit port 62. A valve member 60 in the internal flow passage 58 between the inverted bottle 12 and the fluid exit port 62. A vent tube 82 is supported by the housing portion 56 and extends upward into the inverted bottle 12. Manually-operated valve control means are connected to the valve member 60 for controlling the valve member 60. The vent tube 82 can include a ball valve 84.

The manually-operated valve control means include a valve control rod 64 which is connected to the valve member 60. A valve handle 66 is connected to the valve control rod 64 for controlling the valve control rod 64 and the valve member 60.

If desired, a receiver holder unit 68 can be employed, and the receiver holder unit 68 is attachable to a vertically oriented surface. The receiver holder unit 68 includes a tray portion 70 which includes a plurality of receiver-reception recess positions 72. The receiver-reception recess positions 72 are placed in registration with the inverted bottles 12.

As shown in FIG. 1, a cup 19 is located in one of the receiver-reception recess positions 72 in registration with an inverted bottle 12. The tray portion 70 includes vertical surface attachment tabs 74 extending outward from edge portions of the tray portion 70, and the vertical surface attachment tabs 74 include fastener-reception channels 76. The fastener-reception channels 76 include relatively large fastener reception regions and relatively small fastener reception regions which are adjacent to the relatively large fastener reception regions.

To install the embodiment of the invention shown in FIGS. 1-7 onto a wall 17, screws 42 are threaded through fastener-reception channels in the top mounting strip 14, and the screws 42 are screwed into the wall 17, whereby the top mounting strip 14 is attached to the wall 17.

Then below the top mounting strip 14 an appropriate distance for later mounting of the inverted bottles 12, the bottom mounting strip 20 is installed on the wall 17 using fasteners as well. The bottom mounting strip 20 is installed so that the respective hook-receiver, outward-extending regions 16 and the respective inward-extending, vertical-surface-contacting regions 18 of the top mounting strip 14 and the bottom mounting strip 20 are in registration with each other.

Then, below the bottom mounting strip 20, at an appropriate distance for employing a cup 19 which has a predetermined height, the receiver holder unit 68 is installed on the wall 17 so that the receiver-reception recess positions 72 are in registration with the inverted bottles 12 to be installed on the top mounting strip 14 and the bottom mounting strip 20. To install the receiver holder unit 68 onto the wall 17, fasteners can be used. Washers 80 can also be used with the fasteners. The washers 80 have an outer diameter which is less than the relatively large fastener reception regions and greater than the relatively small fastener reception regions. As a result, after the fasteners and the washers 80 have been located in the relatively large fastener reception regions, by moving the receiver holder unit 68 downward, the relatively small fastener reception regions can be slid onto the fasteners to secure the receiver holder unit 68 to the wall 17.

Conversely, to readily remove the receiver holder unit 68 from the wall 17, the receiver holder unit 68 can be pushed upward so that the fasteners and the washers 80 enter the relatively large fastener reception regions, and the receiver holder unit 68 can then be readily pulled away from and removed from the wall 17.

After the top mounting strip 14, the bottom mounting strip 20, and the receiver holder unit 68 have been installed on the wall 17, one or more inverted bottle support bracket means are installed on the top mounting strip 14 and the bottom mounting strip 20. More specifically, the top hook portion 28 is inserted between a selected hook-receiver, outward-extending region 16 and the wall 17. Similarly, the bottom hook portion 30 is inserted between a selected hook-receiver, outward-extending region 16 in the bottom mounting strip 20 and the wall 17. The hook-receiver, outward-extending region 16 in the bottom mounting strip 20 is in registration with the selected hook-receiver, outward-extending region 16 in the top mounting strip 14.

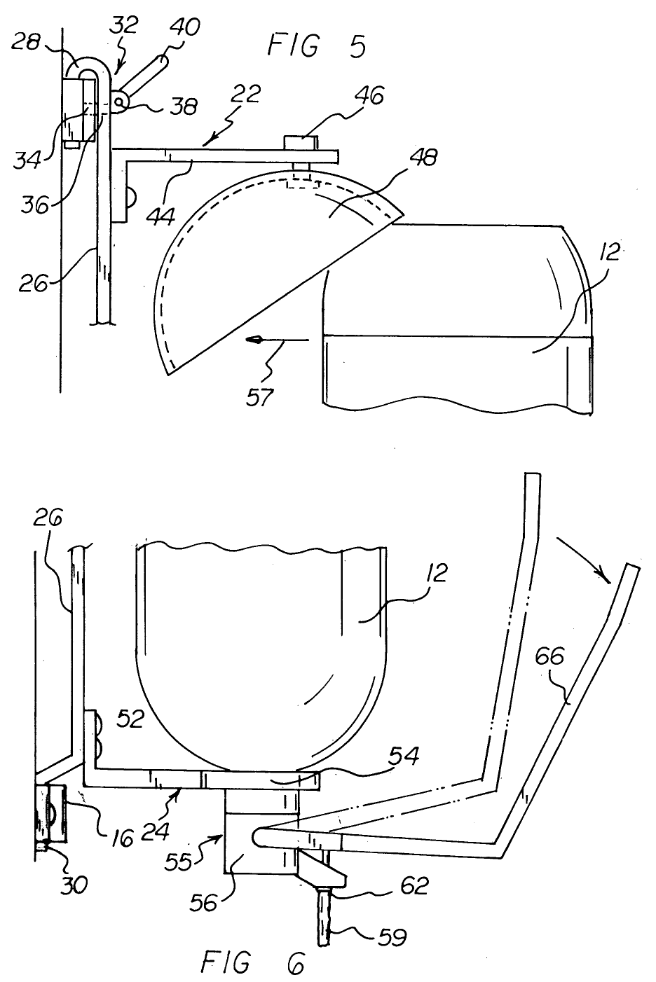

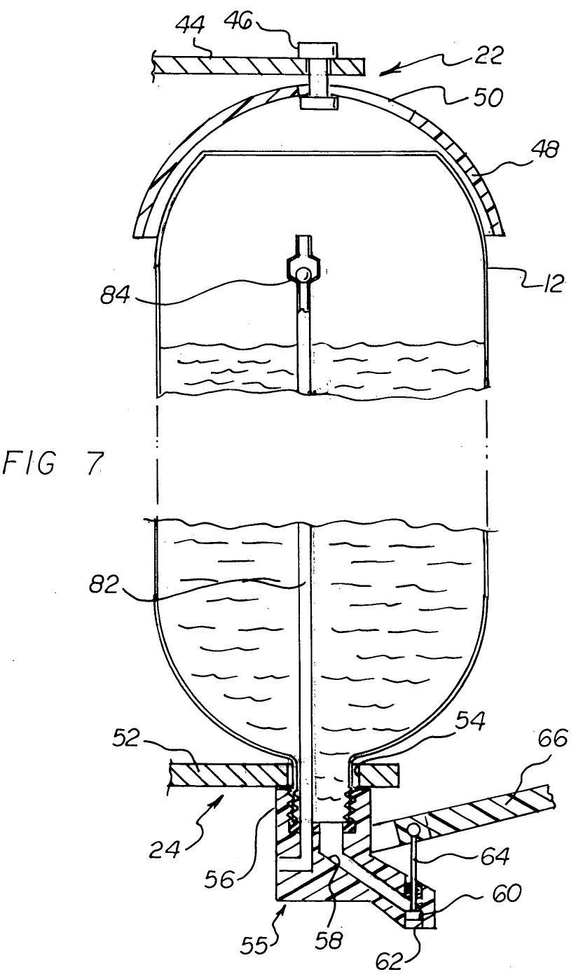

Then, a conventional fluid containing bottle is obtained, and the conventional cap is unscrewed from the bottle. Then, the manually-operated dispenser assembly 55 of the invention is screwed onto the bottle. Then, the bottle is inverted to become an inverted bottle 12. Then, the inverted bottle 12, having the manually-operated dispenser assembly 55 attached thereto, is inserted into the inverted bottle support bracket means. More specifically, the inverted cup member 48 is tilted toward the interconnector bracket strut portion 26 by allowing the cup-supporting bolt 46 to ride in the adjustment slot 50, as shown in FIG. 5. The bottom of the inverted bottle 12 is moved toward the interconnector bracket strut portion 26 in the direction as shown by directional arrow 57. At the same time, top of the inverted bottle 12 is moved into the bottle-neck-reception notch 54. Then, the inverted cup member 48 is tilted back over the bottom of the inverted bottle 12, and the cup-supporting bolt 46 to secure the inverted cup member 48 in the non-tilted position, as shown in FIG. 7.

A cup 19 is placed in a receiver-reception recess position 72 in the receiver holder unit 68 which is in registration with the inverted bottle 12. When the valve handle 66 is operated, as shown in FIG. 6, a fluid flow 59 flows out from the fluid exit port 62, as shown in FIG. 6. The fluid flow 59 falls into the cup 19.

A bracket lock assembly 32 can be connected to the inverted bottle support bracket means. More specifically, the bracket lock assembly 32 includes a pin-reception channel 34 in a hook-receiver, outward-extending region 16. A lock pin 36. A fulcrum 38 mounted on the interconnector bracket strut portion 26, and a lock handle 40 is connected to the lock pin 36 through the fulcrum 38. To lock the bracket lock assembly 32. A top hook portion 28 is hung onto a hook-receiver, outward-extending region 16, and the lock handle 40 is shifted to move the lock pin 36 into the pin-reception channel 34. To unlock the bracket lock assembly 32, the lock handle 40 is moved in an opposite direction to move the lock pin 36 out from the pin-reception channel 34.

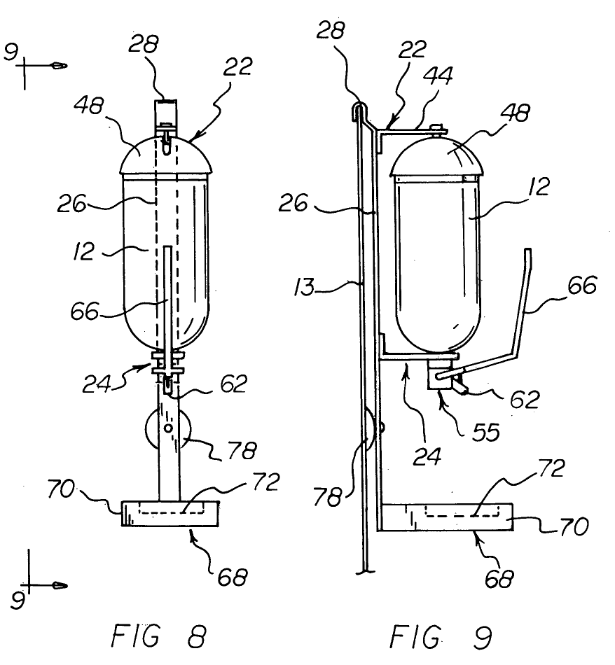

Turning to the second embodiment of the first class of the apparatuses of the invention shown in FIGS. 8-9, reference numerals are shown that correspond to like reference numerals that designate like elements shown in the other figures. In addition, the bottle-bracket-to-surface-mount connection means include a bottom suction cup portion 78 is connected to a bottom portion of the interconnector bracket strut portion 26. Also, a receiver holder unit 68 is connected to a distal bottom portion of an interconnector bracket strut portion 26 of the inverted bottle support bracket means.

As shown in FIG. 9, the second embodiment of the invention is installed on an automobile window 13. More specifically, the automobile window 13 is partially lowered, and the top hook portion 28 is placed over the top edge of the window glass. Then, the automobile window 13 is raised to trap the top hook portion 28 between the top edge of the window glass and the window frame on the automobile door. The bottom suction cup portion 78 is pressed up against the window glass to firmly secure the second embodiment of the invention on the automobile window 13. Removing the second embodiment of the invention from the automobile window 13 is accomplished by reversing the steps for installation.

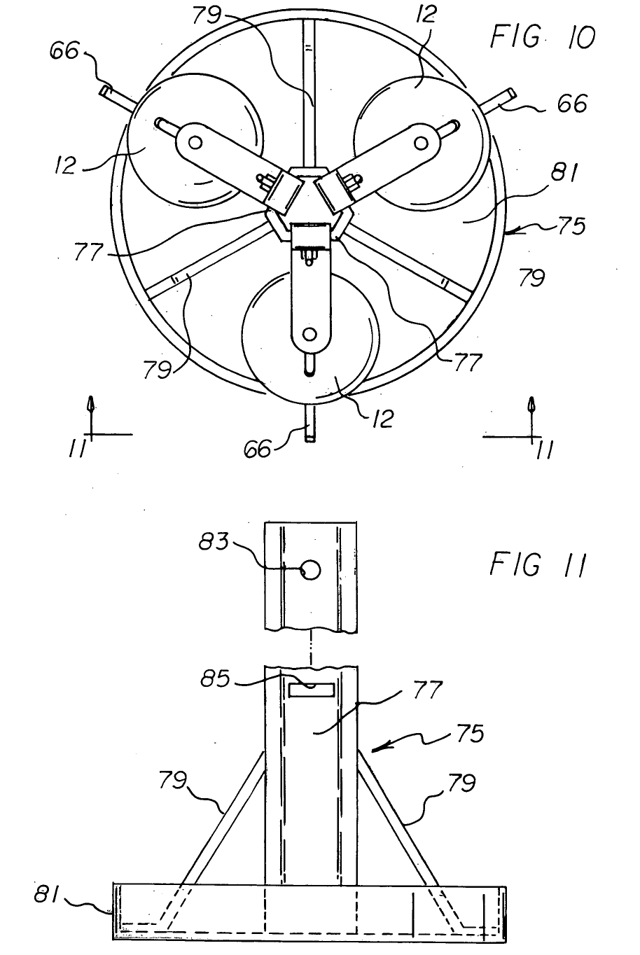

Turning to the third embodiment of the first class of apparatuses of the invention, which is a self-supported rack, shown in FIGS. 10-11, reference numerals are shown that correspond to like reference numerals that designate like elements shown in the other figures. In addition, rack assembly 75 is provided which includes a vertically oriented bracket support unit. Unit support means are connected to the vertically oriented bracket support unit, for supporting the vertically oriented bracket support unit in the vertical orientation.

More specifically, the vertically oriented bracket support unit includes a plurality vertically oriented bracket support struts 77 arranged in a circular arrangement, and the unit support means include a plurality of support legs 79 arranged in a circular arrangement around the vertically oriented bracket support struts 77.

Each of the vertically oriented bracket support struts 77 includes a top hook reception aperture 83 and a bottom hook reception aperture 85. A tray 81 can be placed under the support legs 79. The tray 81 can include receiver-reception recess positions 72, if desired.

To use the third embodiment of the invention shown in FIGS. 10 and 11, the tray 81 is placed on a horizontal surface, such as a table top or desk top. Then, the rack assembly 75 is lowered into the tray 81. An inverted bottle 12 is mounted on inverted bottle support bracket means, and the inverted bottle support bracket means are mounted onto the vertically oriented bracket support struts 77. More specifically, the top hook portion 28 is passed through the top hook reception aperture 83, and the bottom hook portion 30 is passed through the bottom hook reception aperture 85. Then, the respective hook portions are lowered in the respective apertures, whereby the inverted bottle support bracket means is mounted on a respective vertically oriented bracket support struts 77.

Operation of each manually-operated dispenser assembly 55 is carried out as described above with respect to other embodiments of the invention. Also, operation of each bracket lock assembly 32 is carried out as described above. As shown in FIGS. 10-11, three inverted bottles 12 can be supported by the rack assembly 75.

If desired, the tray 81 and the rack assembly 75 can be provided as a single unit. The support legs 79 and the tray 81 provide stability to the inverted bottles 12 that are supported by the vertically oriented bracket support struts 77.

If desired, the inverted bottles 12 can be provided with covers that includes printed matter, such as corporate logos. The bottle covers can be in the form of bags that slide over the inverted bottles 12.

Various embodiments of the invention can be used in homes, hotel rooms, and private party rooms. With the invention, beverage dispensing machines such as found in restaurants can be brought into ones home, etc.

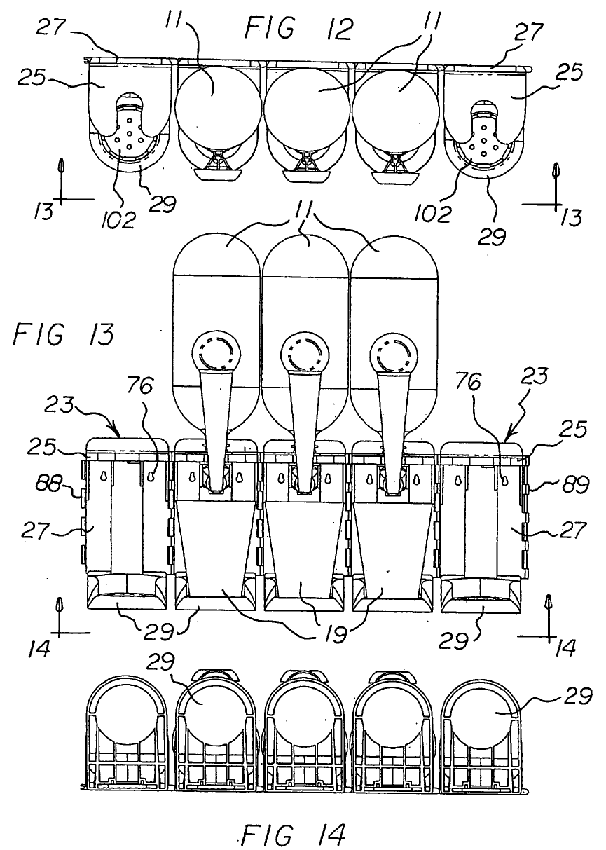

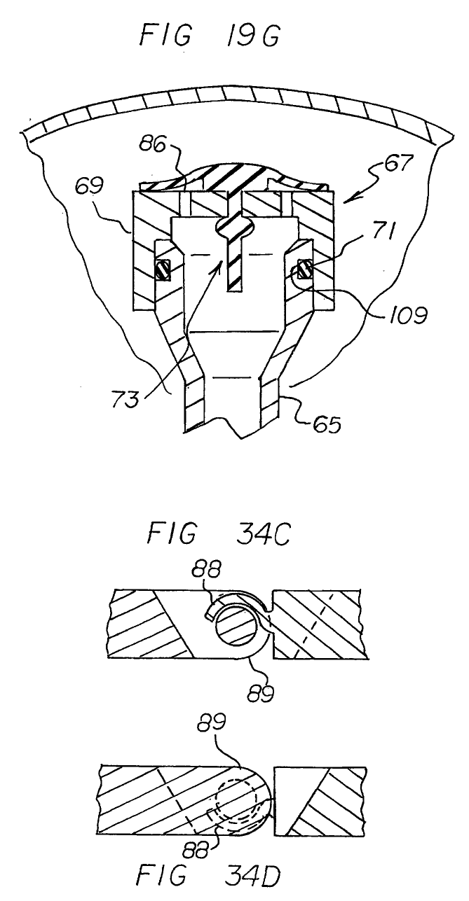

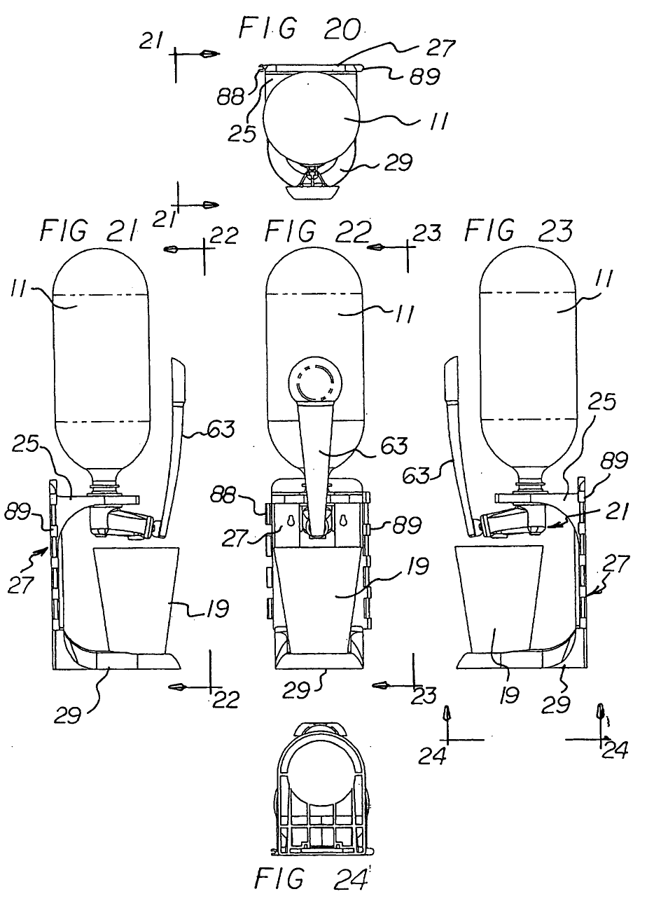

In accordance with a second class of inverted bottle support and dispenser apparatuses of the invention, as shown in FIGS. 12 through 36, such an apparatus includes a combination dispensing valve and vent tube unit 21 for connecting to a bottle 11 and a combination support unit 23 for supporting the combination dispensing valve and vent tube unit 21. Preferably, the combination support unit 23 includes a top bracket portion 25 for receiving the combination dispensing valve and vent tube unit 21, a riser bracket portion 27 connected to the top bracket portion 25 and descending downward therefrom, and a bottom bracket portion 29 connected to a bottom end of the riser bracket portion 27. Preferably, the bottom bracket portion 29 includes a receiver-reception recess position 72, and a drip screen 102 is received in the receiver-reception recess position 72. The drip screen 102 has holes that permit drips from the spout portion 41 of the valve assembly 45 to move under the top of the drip screen 102. Later, the drip screen 102 can be removed, and the receiver-reception recess position 72 under the drip screen 102 can be cleaned. Alternatively, the bottom bracket portion 29 can be removed from the riser bracket portion 27 to clean the entire bottom bracket portion 29 without disassembling the remainder of the apparatus.

In addition, the riser bracket portion 27 includes fastener-reception channels 76. The fastener-reception channels 76 permit reception of fasteners, such as screws, for allowing mounting of the riser bracket portion 27, and thereby the inverted bottle support and dispenser apparatus of the invention, on a vertically oriented surface such as a vertically oriented wall 17, such as shown in FIG. 4.

Preferably, the combination dispensing valve and vent tube unit 21 includes a valve body 31 which includes a support-unit-engagement portion 49 for engaging the combination support unit 23, a bottle-reception inlet portion 37, a vent-tube-reception channel 35, a valve seat portion 39, a spout portion 41, and a valve-assembly-reception channel 43. A vent tube assembly 33 is received in the vent-tube-reception channel 35. The combination dispensing valve and vent tube unit 21 also includes a valve assembly 45, a portion of which is received in the valve-assembly-reception channel 43 for retention inside the valve body 31. A valve cap 47 is provided for retaining a portion of the valve assembly 45 in the valve body 31 and for permitting easy removal of the valve assembly 45 from the valve body 31.

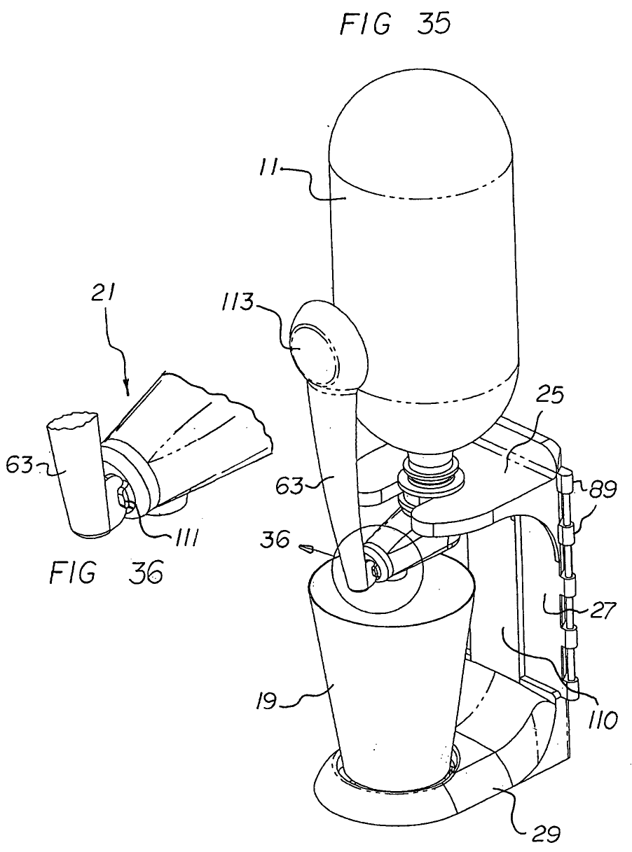

Preferably, the valve assembly 45 includes a valve and actuator member 51 which includes a valve portion 53 and an actuator portion 57 connected to the valve portion 53. A valve operation handle 63 is connected to the actuator portion 57, and a sealing member 61 is connected to the valve and actuator member 51 for sealing the valve and actuator member 51 with respect to the valve body 31. A bias spring 64 is located between the valve portion 53 and the valve cap 47 for urging a distal end of the valve portion 53 against the valve seat portion 39 for retaining the valve portion 53 in a closed position. The valve operation handle 63 is shown to have a large circular area 112 (see FIG. 35) in which a logo 113 can be placed. The valve operation handle 63 has a length to ensure sufficient leverage so that there is no undue pressure needed by the user, and there is an ease of operation.

Preferably, the valve operation handle 63 includes a valve cap contacting end 87, and the valve cap contacting end 87 is round. Preferably, the valve and actuator member 51 and the sealing member 61 are provided as a unified, integrated structure. Preferably, the valve operation handle 63 is connected to the actuator portion 57 by means of a pivoted handle-to-actuator connection.

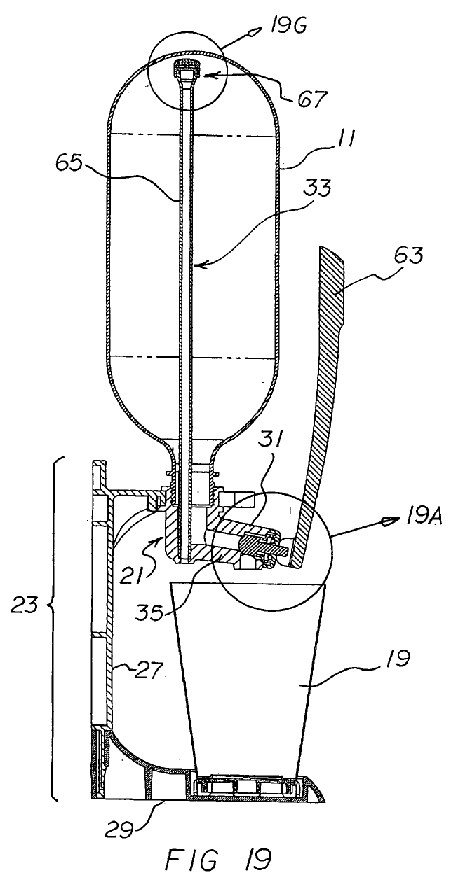

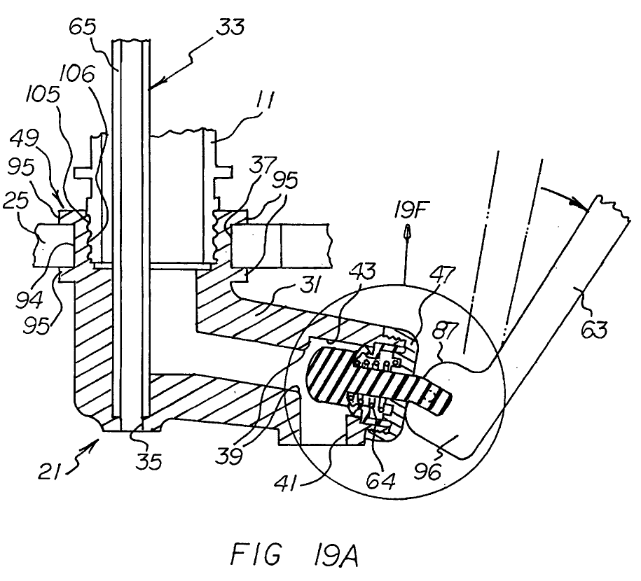

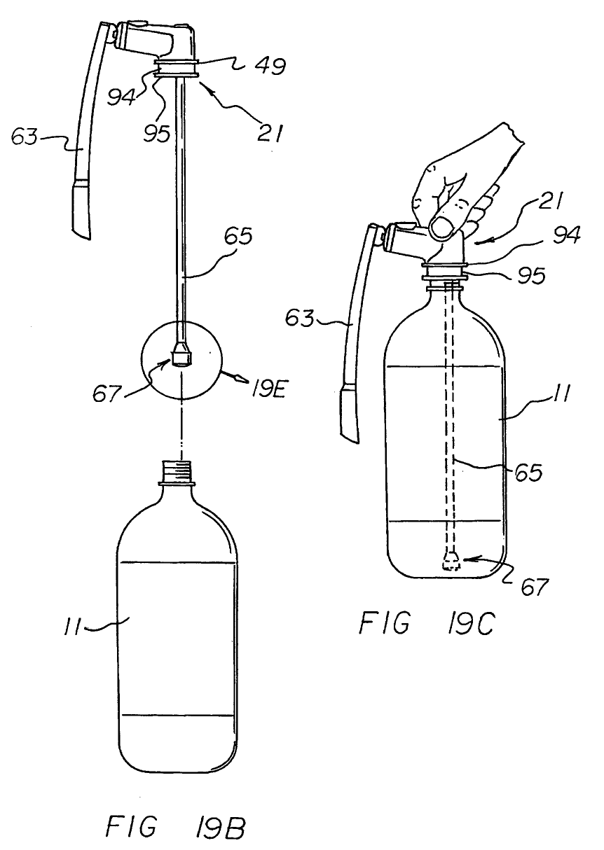

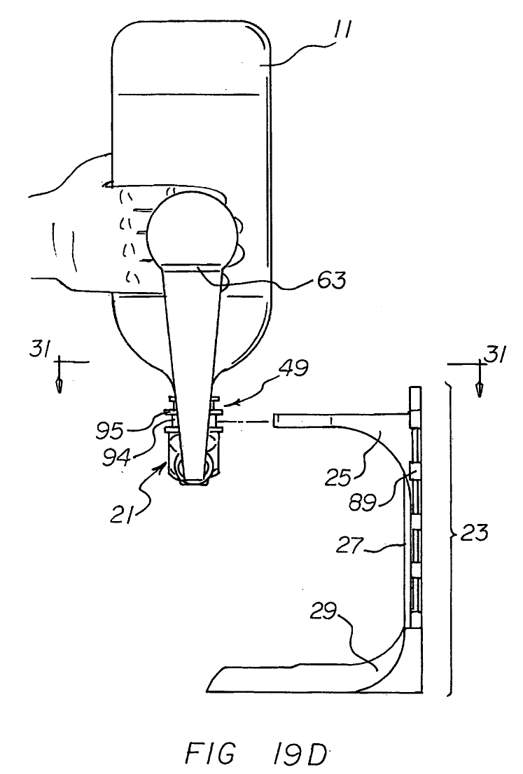

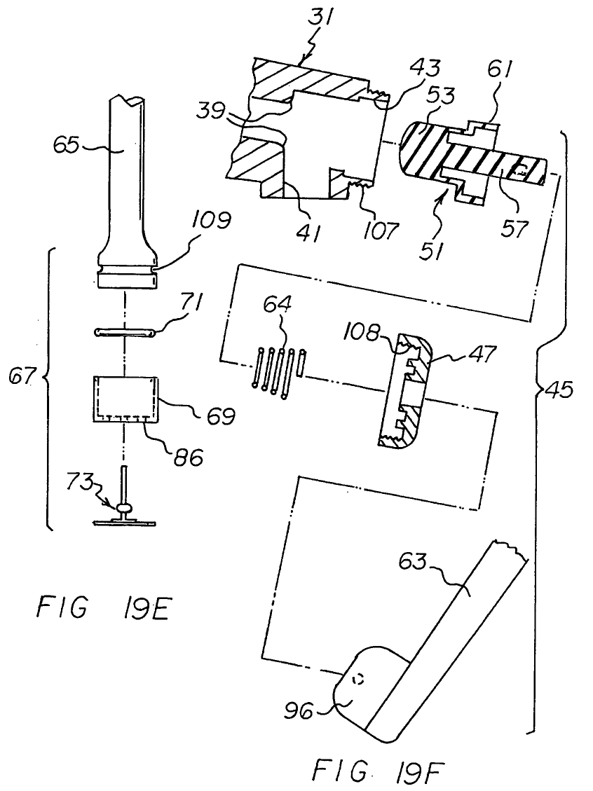

Preferably, the vent tube assembly 33 includes a vent tube 65 received in the vent-tube-reception channel 35, and a vent tube air valve assembly 67 is connected to a distal end of the vent tube 65. Preferably, the vent tube air valve assembly 67 includes an air valve housing 69 which includes one or more vent holes 86. A sealing ring 71 removably fixed onto the vent tube 65 between the vent tube 65 and the air valve housing 69, and a one-way valve element 73 is connected to the air valve housing 69 for covering the one or more vent holes 86. The one-way valve element 73 preferably is removably connected to the air valve housing 69 by means of a resilient protuberant (unlabeled) substantially as shown in FIG. 19G. The one-way valve element 73 can be made from soft rubber (e.g. silicone rubber) and be in the form of a button valve.

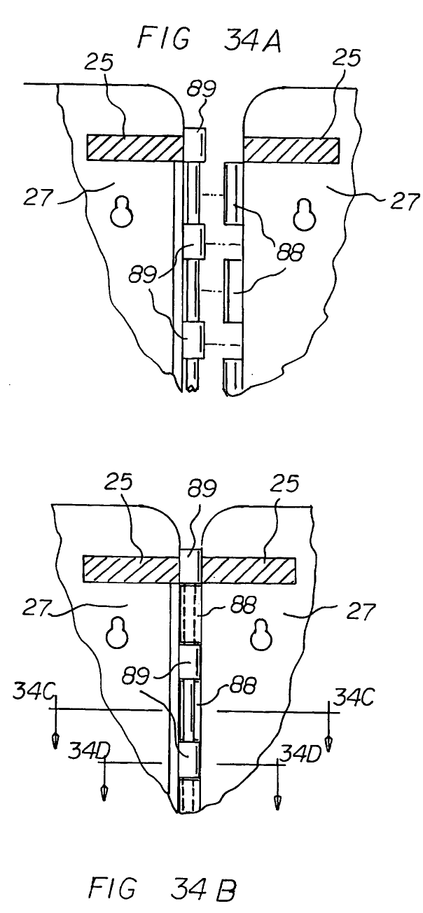

Preferably, the riser bracket portion 27 includes riser first side connectors 88 located on one side of the riser bracket portion 27 and complementary riser second side connectors 89 located on an opposite side of the riser bracket portion 27. The riser first side connectors 88 of one riser bracket portion 27 engage with the complementary riser second side connectors 89 of an adjacent riser bracket portion 27 when a plurality of apparatuses are used together. The riser first side connectors 88 can be resilient female-like members, and the riser second side connectors 89 can be complementary male-like members. More specifically, the resilient female-like riser first side connectors 88 and the complementary male-like riser second side connectors 89 interlock together to form an interlocking hinge substantially as shown in FIGS. 34A-34D.

Also, the top bracket portion 25 includes top-to-riser connectors, and the riser bracket portion 27 includes riser-to-top connectors and riser-to-bottom connectors 92. The riser-to-top connectors engage the top-to-riser connectors, and the bottom bracket portion 29 includes bottom-to-riser connectors 93 which engage the riser-to-bottom connectors 92.

The support-unit-engagement portion 49 includes inner wall portions 94 and outer flange portions 95. The inner wall portions 94 includes opposed flat inner wall portions 97 and opposed round inner wall portions 98. The top bracket portion 25 includes opposed flat inner wall portions 90 and a round inner wall portion 91. The opposed flat inner wall portions 90 of the top bracket portion 25 are separated from each other by a first separation distance 99, and the round inner wall portion 91 has an internal diameter 101 which is greater than the first separation distance 99. The opposed round inner wall portions 98 are separated from each other by a second separation distance 100 which is greater than the first separation distance 99. The internal diameter 101 of the round inner wall portion 91 and the second separation distance 100 of the opposed round inner wall portions 98 are substantially equal.

Uses of the embodiments of the invention illustrated in FIGS. 12 through 36 are set forth below.

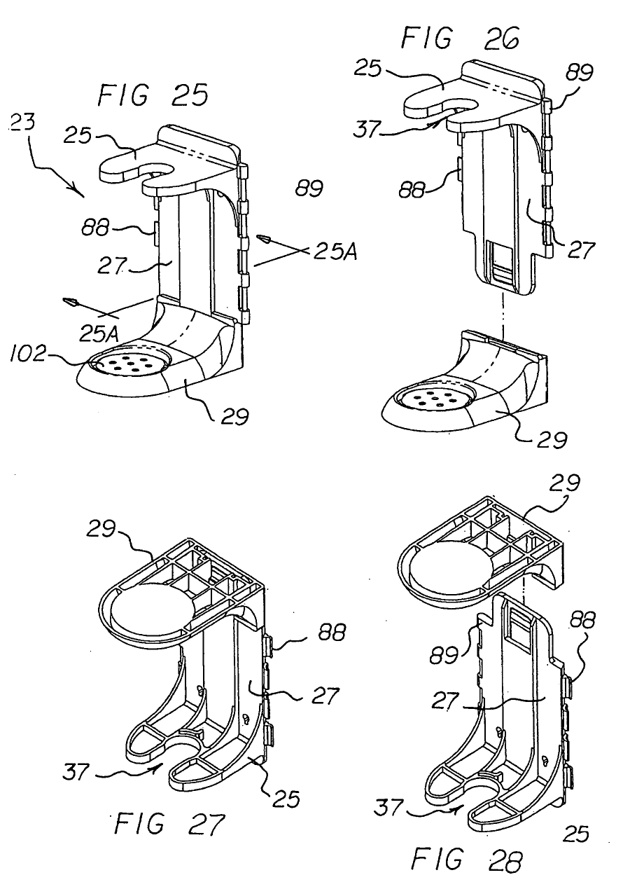

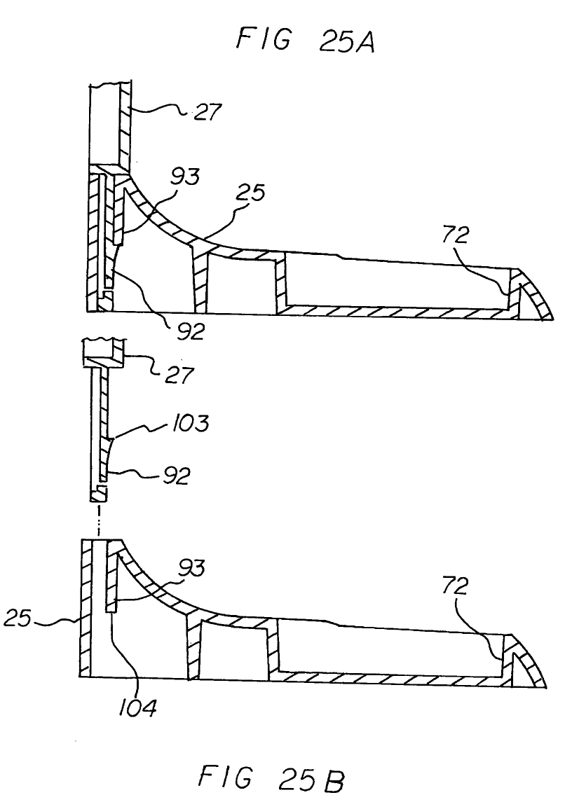

With most specific reference to FIGS. 25-28, the combination support unit 23 is assembled as follows. As shown in FIG. 25B, the riser bracket portion 27 is grasped by a person, and the bottom portion of the riser bracket portion 27 is brought toward the bottom bracket portion 29 which is resting on a horizontally oriented surface, such as a table top. The riser-to-bottom connectors 92 of the riser bracket portion 27 are inserted into the complementary bottom-to-riser connectors 93 of the bottom bracket portion 29, as shown in FIG. 25A. More specifically, the riser-to-bottom connectors 92 includes locking barbs 103 which engage locking-barb reception surfaces 104 in the bottom bracket portion 29. In this way, the riser bracket portion 27 is locked onto the bottom bracket portion 29.

In addition, the top-to-riser connectors of the top bracket portion 25 can includes locking barbs 103 to engage complementary locking-barb reception surfaces 104 in the riser-to-top connectors of the riser bracket portion 27.

In FIGS. 29, 30, and 35, an embodiment of the riser bracket portion 27 is shown that has an additional rib 110 extending from the top to the bottom of the riser bracket portion 27. This additional rib provides reinforcement, especially when an extra heavy bottle 11 is used, such as a three liter beverage bottle.

It is noted that the combination dispensing valve and vent tube unit 21 in FIG. 36 has a sideways movement lock 111 at the base of the handle pivot tab 96 of the valve operation handle 63 that prevents sideways movement of the valve operation handle 63 when the valve operation handle 63 is operated.

To disassemble a top bracket portion 25 from a riser bracket portion 27 or to disassemble a riser bracket portion 27 from a bottom bracket portion 29, the respective locking barbs 103 are disengaged from the respective locking-barb reception surfaces 104, and the respective bracket portions are pulled apart.

In a similar way, the top bracket portion 25 is locked onto the riser bracket portion 27. That is, the top-to-riser connectors of the top bracket portion 25 interlock with the riser-to-top connectors of the riser bracket portion 27.

Once the combination support unit 23 is fully assembled, attention is directed to installing the combination dispensing valve and vent tube unit 21 onto a bottle 11, as illustrated in FIGS. 19B and 19C. More specifically, an upright-standing bottle 11 is placed on a horizontally oriented surface, and the cap of the upright-standing bottle 11 has been removed from the bottle 11. Then, the combination dispensing valve and vent tube unit 21 is lowered toward the bottle 11 so that the vent tube air valve assembly 67 and the vent tube 65 enter the bottle 11. The combination dispensing valve and vent tube unit 21 is screwed onto the bottle 11, as shown in FIG. 19C. More specifically, the external threads 105 of the inverted bottle 11 are engaged with complementary internal threads 106 of the valve body 31.

Once the combination dispensing valve and vent tube unit 21 and the bottle 11 are connected together, the bottle 11 is inverted, as shown in FIG. 19D. Then, the inverted bottle 11 is, in combination with the combination dispensing valve and vent tube unit 21, is moved toward the assembled combination support unit 23 so that the support-unit-engagement portion 49 of the combination dispensing valve and vent tube unit 21 engages the bottle-reception inlet portion 37 of the top bracket portion 25.

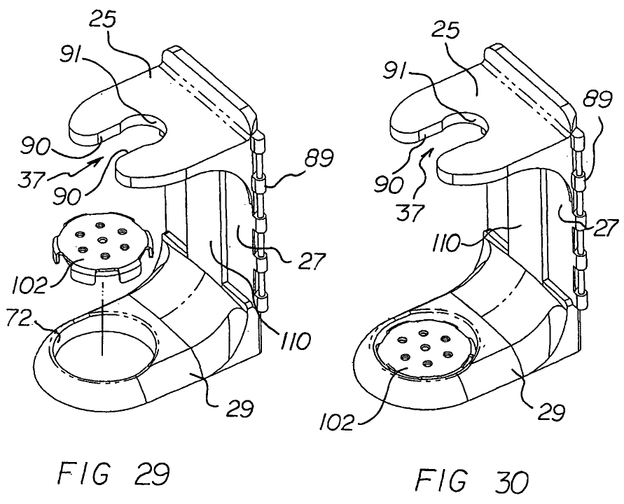

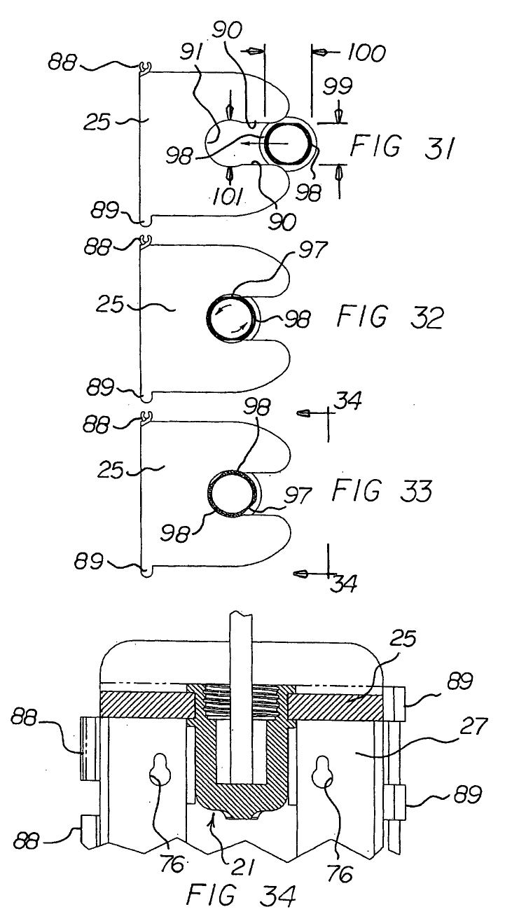

More specifically, with reference to FIGS. 31-33, the combination dispensing valve and vent tube unit 21 is installed on the combination support unit 23 as follows. As shown in FIG. 31, the combination dispensing valve and vent tube unit 21 is oriented so that the opposed flat inner wall portions 97 of the support-unit-engagement portion 49 of the valve body 31 are parallel to the opposed flat inner wall portions 90 of the bottle-reception inlet portion 37 in the top bracket portion 25. Then, as shown in FIG. 32, the support-unit-engagement portion 49 is moved into the bottle-reception inlet portion 37 so that one of the opposed round inner wall portions 98 of the support-unit-engagement portion 49 contacts the round inner wall portion 91 of the top bracket portion 25. Then, as indicated by the rotational arrows in FIG. 32, the combination dispensing valve and vent tube unit 21 is rotated within the round inner wall portion 91 of the top bracket portion 25 to that the opposed round inner wall portions 98 wedge up against the round inner wall portion 91, as shown in FIG. 33. This wedging action between the opposed round inner wall portions 98 of the support-unit-engagement portion 49 and the round inner wall portion 91 of the top bracket portion 25 provide a tight and secure connection between the combination dispensing valve and vent tube unit 21, with the inverted bottle 11 attached thereto, and the combination support unit 23.

Once the combination dispensing valve and vent tube unit 21 is secured to the combination support unit 23, the valve operation handle 63 can be operated to dispense a contained liquid from the inverted bottle 11. More specifically, with reference to FIGS. 19, 19A, and 19F, a user grasps the valve operation handle 63 and pulls on it in a direction away from the bottle 11. When this is done, the valve cap contacting end 87 of the handle pivot tab 96 of the valve operation handle 63 contacts the valve cap 47 and pulls on the actuator portion 57 of the valve and actuator member 51, thereby overcoming the spring bias of the bias spring 64. A pivoted handle-to-actuator connection is used to connect the handle pivot tab 96 to the actuator portion 57 of the valve and actuator member 51. As this pulling on the valve operation handle 63 is done, the actuator portion 57 of the valve and actuator member 51 pulls the valve portion 53 away from the valve seat portion 39, thereby allowing liquid to flow from the inverted bottle 11, through the valve body 31, past the valve seat portion 39, and out through the spout portion 41 and into a receiving cup 19 placed on the bottom bracket portion 29. When no more liquid is to be dispensed from the spout portion 41, the valve operation handle 63 is released, and the bias spring 64 returns the valve portion 53 onto the valve seat portion 39 to prevent further liquid from being dispensed from the inverted bottle 11.

Also, as liquid is dispensed from the inverted bottle 11, replacement air enters the open end of the vent tube 65 and pushes the one-way valve element 73 off of the one or more vent holes 86 in the air valve housing 69, thereby allowing the replacement air to enter the inverted bottle 11 above the level of liquid in the inverted bottle 11. However, once the valve portion 53 closes against the valve seat portion 39 and liquid ceases to flow from the inverted bottle 11, the force of gravity causes the one-way valve element 73 to drop onto the one or more vent holes 86 and prevent any material inside the inverted bottle 11 from exiting from the inverted bottle 11 out the vent tube 65.

When it is desired to change the inverted bottle 11, the combination dispensing valve and vent tube unit 21 is removed from the combination support unit 23 by reversing the above-described installation steps so that the combination dispensing valve and vent tube unit 21 is disengaged from the combination support unit 23. Then, the inverted bottle 11 to an upright-standing orientation, and the bottle 11 is unscrewed from the combination dispensing valve and vent tube unit 21.

When it is desired to clean the combination dispensing valve and vent tube unit 21, both the valve assembly 45 and the vent tube air valve assembly 67 can be cleaned separately.

More specifically, to clean the valve assembly 45, the bottle 11 is unscrewed and removed from the combination dispensing valve and vent tube unit 21. That is, the external threads 105 of the bottle 11 are unscrewed from the internal threads 106 of the valve body 31, and the bottle 11 is moved away from both the vent tube 65 and the vent tube air valve assembly 67. Then, the valve cap 47 is unscrewed from the valve body 31. That is, the internal threads 108 of the valve cap 47 are unscrewed from the complementary external threads 107 near the valve-assembly-reception channel 43 of the valve body 31. When the valve cap 47 is removed from the valve body 31, the bias spring 64 expands, and the valve and actuator member 51 can easily be pulled out from the valve body 31 through the valve-assembly-reception channel 43. Then, the components of the valve assembly 45 can be easily cleaned.

The valve assembly 45 can be easily reassembled by inserting the valve and actuator member 51 into the valve body 31 through the valve-assembly-reception channel 43, by placing the distal end of the bias spring 64 against the back side of the valve portion 53, by pressing the inside of the valve cap 47 against the proximal end of the bias spring 64, by pushing against the bias spring 64 with the valve cap 47 to compress the bias spring 64, and by screwing the internal threads 108 of the valve cap 47 onto the external threads 107 of the valve body 31. Once this is done, the valve assembly 45 is reassembled.

More specifically, to clean the vent tube air valve assembly 67, with special reference to FIG. 19E, the air valve housing 69 is pulled off of the vent tube 65. It is noted that the air valve housing 69 is retained on the vent tube 65 by a friction fit of the air valve housing 69 onto a sealing ring 71 which is retained in an annular retaining channel 109 at the end of the vent tube 65. When the air valve housing 69 has been removed from the vent tube 65, the sealing ring 71, and the annular retaining channel 109, then the air valve housing 69, the one or more vent holes 86 in the air valve housing 69, and the one-way valve element 73 can be readily cleaned, dried, and reassembled.

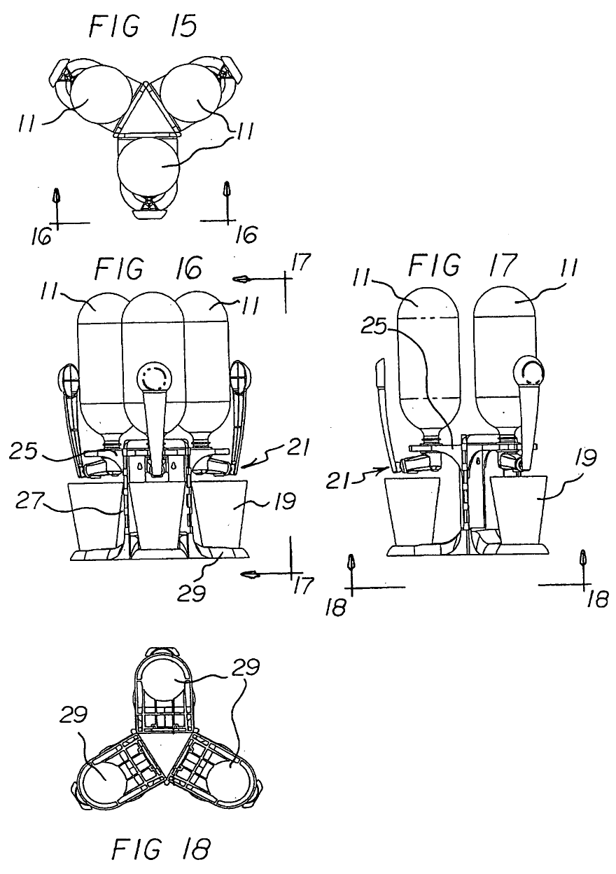

With a plurality of inverted bottle support and dispenser apparatuses of the invention are used together, wherein each apparatus includes a combination dispensing valve and vent tube unit 21 and a combination support unit 23, the top bracket portions 25 can be interchangeable, the riser bracket portions 27 can be interchangeable, and the bottom bracket portions 29 can be interchangeable. A plurality of such inverted bottle support and dispenser apparatuses of the invention are shown in FIGS. 12-14 and in FIGS. 15-18.

Interchangeable parts provide simplicity and ease of manufacture. The respective interchangeable parts can be made by a number of manufacturing processes such as by injection molding or extrusion. The preferred material of manufacture is a polyamide, such as a nylon resin. Other polymeric materials can also be used such as polycarbonates, among others.

With the plurality of inverted bottle support and dispenser apparatuses of the invention shown in FIGS. 12-14, the respective apparatuses are mounted in side-by-side relation to each other on a vertically oriented wall surface. It is noted that in FIGS. 12-14, five apparatuses are wall mounted, but only the middle three of the five apparatuses include an inverted bottle 11. The unused end two apparatuses can be used at a later time. To mount the plurality of inverted bottle support and dispenser apparatuses of the invention on the vertically oriented wall surface, fasteners, such as screws, are inserted through the fastener-reception channels 76 in the respective riser bracket portions 27 of the individual apparatuses, thereby securing the individual apparatuses onto the vertically oriented wall surface. Instead of being mounted directly on a vertical wall surface, the plurality of apparatuses of the invention can be mounted in side-by-side relation on a mounting plank or other structure that is, in turn, mounted on the wall.

The respective apparatuses of the invention are connected together in side-by-side relationship by interconnecting the riser first side connectors 88 of one apparatus to the complementary riser second side connectors 89 of an adjacent apparatus. More specifically, the resilient female-like riser first side connectors 88 are interconnected with complementary male-like riser second side connectors 89. The resilient female-like riser first side connectors 88 connect with the complementary male-like riser second side connectors 89 with a snap action.

In contrast, with the plurality of inverted bottle support and dispenser apparatuses of the invention shown in FIGS. 15-18, three respective apparatuses of the invention are mounted in a triangular relation to each other on a horizontally oriented surface, such as a table top. To secure the apparatuses to each other, respective resilient female-like riser first side connectors 88 on one apparatus are interconnected with respective complementary male-like riser second side connectors 89 on an adjacent apparatus.

With respect to the three apparatuses shown in FIGS. 15-18, the three apparatuses form a three-sided polygon, that is a triangle. If desired, four apparatuses can be used to form a four-sided polygon, such as a square, five apparatuses can be used to form a five-sided polygon, such as a pentagon, six apparatuses can be used to form a six-sided polygon, such as a hexagon, and so forth.

In addition, six apparatuses can be used for forming a four-sided rectangle with two apparatuses on each long side of the rectangle and one apparatus on each short side of the rectangle.

More generally, an even number of apparatuses of the invention can be used for form a polygonal array of apparatuses that has an even number of sides.

Generally, the components of all classes of the inverted bottle support and dispenser apparatus of the invention can be made from inexpensive and durable metal and, preferably, plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved inverted bottle support and dispenser apparatus that is low in cost, relatively simple in design and operation, and which may advantageously includes a one-way check valve that does not include a plurality of O-rings for sealing and is easily disassembled for cleaning. With the invention, an apparatus is provided which permits the liquid to be dispensed simply by the force of gravity without providing a positive air pressure to the inside of the inverted bottle. With the invention, an apparatus is provided which does not include an expandable bladder attached to a vent tube. With the invention, an apparatus is provided which does not require a single valve assembly to control both replacement air through a vent tube and liquid dispensed from the inverted bottle. With the invention, an apparatus provides a single device for dispensing liquids from an inverted bottle that can be optionally supported by either a vertically oriented support structure or a horizontally oriented support structure. With the invention, an apparatus is provided which is modular in nature and that can be combined with other such modular devices to provide a combination of a plurality of modular devices for dispensing liquids from a plurality of inverted bottles. With the invention, an apparatus provides interchangeable components for the modular devices. With the invention, an apparatus is provided which permits easy disassembly, easy cleaning, and easy reassembly of both a vent tube air valve assembly and a valve assembly for liquid flow control.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

1. An inverted bottle support and dispenser apparatus, comprising:
vertical surface mounting means,
inverted bottle support bracket means,
bottle-bracket-to-surface-mount connection means connected between said inverted bottle support bracket means and said vertical surface mounting means,
an inverted bottle supported by said inverted bottle support bracket means, and
manually-operated dispenser assembly means connected to said inverted bottle.

2. The apparatus of claim 1 wherein said vertical surface mounting means include a top mounting strip which includes a plurality of hook-receiver, outward-extending regions and a plurality of inward-extending, vertical-surface-contacting regions interspersed between said hook-receiver, outward-extending regions.

3. The apparatus of claim 2 wherein:
said vertical surface mounting means further include a bottom mounting strip which includes a plurality of hook-receiver, outward-extending regions and a plurality of inward-extending, vertical-surface-contacting regions interspersed between said hook-receiver, outward-extending regions, and
said respective hook-receiver, outward-extending regions and respective inward-extending, vertical-surface-contacting regions of said top mounting strip and said bottom mounting strip are placed in registration when said top mounting strip and said bottom mounting strip are mounted on a vertical surface.

4. The apparatus of claim 1 wherein said inverted bottle support bracket means include:
a top bracket portion for engaging a bottom portion of said inverted bottle,
a bottom bracket portion for supporting a top portion of said inverted bottle, and
an interconnector bracket strut portion connected between said top bracket portion and said bottom bracket portion.

5. The apparatus of claim 4 wherein said bottle-bracket-to-surface-mount connection means include:
a bottom suction cup portion connected to a bottom portion of said interconnector bracket strut portion.

6. The apparatus of claim 5, further including:
a receiver holder unit connected to a distal bottom portion of an interconnector bracket strut portion of said inverted bottle support bracket means.

7. The apparatus of claim 4 wherein said top bracket portion includes:
a forward projecting top strut connected to said interconnector bracket strut portion,
a cup-supporting bolt connected to a distal end of said forward projecting top strut, and
an inverted cup member connected to said cup-supporting bolt.

8. The apparatus of claim 7 wherein said inverted cup member includes an adjustment slot in which a bottom end of said cup-supporting bolt rides.

9. The apparatus of claim 4 wherein said bottom bracket portion includes:
a forward projecting bottom strut connected to said interconnector bracket strut portion, and
a bottle-neck-reception notch located at a distal end of said forward projecting bottom strut.

10. The apparatus of claim 9 wherein said bottle-neck-reception notch is C-shaped.

11. The apparatus of claim 4 wherein said bottle-bracket-to-surface-mount connection means include:
a top hook portion connected to a top portion of said interconnector bracket strut portion, and
a bottom hook portion connected to a bottom portion of said interconnector bracket strut portion.

12. The apparatus of claim 1 wherein said manually-operated dispenser assembly means include a manually-operated dispenser assembly which includes:
a housing portion which includes internal threads for engaging external threads of said inverted bottle,
a fluid flow passage in said housing portion which is fluid communication with the interior of said inverted bottle, wherein said fluid flow passage includes a fluid exit port,
a valve member in said internal flow passage between said inverted bottle and said fluid exit port,
a vent tube, supported by said housing portion, and extending upward into said inverted bottle, and
manually-operated valve control means connected to said valve member for controlling said valve member.

13. The apparatus of claim 12 wherein said vent tube includes a ball valve.

14. The apparatus of claim 12 wherein said manually-operated valve control means include:
a valve control rod connected to said valve member,
a valve handle connected to said valve control rod for controlling said valve control rod and said valve member.

15. The apparatus of claim 1, further including:
a receiver holder unit attachable to a vertically oriented surface, wherein said receiver holder unit includes a tray portion which includes a plurality of receiver-reception recess positions, wherein said receiver-reception recess positions are placed in registration with said inverted bottles.

16. The apparatus of claim 15 wherein:
said tray portion includes vertical surface attachment tabs extending outward from edge portions of said tray portion, and
said vertical surface attachment tabs include fastener-reception channels.

17. The apparatus of claim 16 wherein said fastener-reception channels include relatively large fastener reception regions and relatively small fastener reception regions adjacent to said relatively large fastener reception regions.

18. The apparatus of claim 1, further including:
a bracket lock assembly connected to said inverted bottle support bracket means.

19. The apparatus of claim 1, further including a rack assembly which includes:
a vertically oriented bracket support unit, and
unit support means, connected to said vertically oriented bracket support unit, for supporting said vertically oriented bracket support unit in the vertical orientation.

20. The apparatus of claim 19 wherein:
said vertically oriented bracket support unit include a plurality vertically oriented bracket support struts arranged in a circular arrangement, and
said unit support means include a plurality of support legs arranged in a circular arrangement around said vertically oriented bracket support struts.

21. The apparatus of claim 20 wherein each of said vertically oriented bracket support struts includes a top hook reception aperture and a bottom hook reception aperture.

22. The apparatus of claim 20, further including:
a tray placed under said support legs.

23. An inverted bottle support and dispenser apparatus, comprising:
a combination dispensing valve and vent tube unit for connecting to a bottle,
a combination support unit for supporting said combination dispensing valve and vent tube unit,
wherein said combination support unit includes a top bracket portion for receiving said combination dispensing valve and vent tube unit, a riser bracket portion connected to said top bracket portion and descending downward therefrom, and a bottom bracket portion connected to a bottom end of said riser bracket portion.

24. The apparatus of claim 23 wherein said bottom bracket portion includes a receiver-reception recess position.

25. The apparatus of claim 24, further including:
a drip screen received in said receiver-reception recess position.

26. The apparatus of claim 23 wherein said riser bracket portion includes fastener-reception channels.

27. The apparatus of claim 23 wherein said combination dispensing valve and vent tube unit includes:
a valve body which includes a support-unit-engagement portion for engaging said combination support unit, a bottle-reception inlet portion, a vent-tube-reception channel, a valve seat portion, a spout portion, and a valve-assembly-reception channel,
a vent tube assembly received in said vent-tube-reception channel,
a valve assembly, a portion of which is received in said valve-assembly-reception channel for retention inside said valve body, and
a valve cap removably connected to said valve body for retaining a portion of said valve assembly in said valve body and for permitting removal of said valve assembly from said valve body.

28. The apparatus of claim 27 wherein said valve assembly includes:
a valve and actuator member which includes a valve portion and an actuator portion connected to said valve portion,
a valve operation handle connected to said actuator portion, and
a sealing member connected to said valve and actuator member for sealing said valve and actuator member with respect to said valve body.

29. The apparatus of claim 28, further including:
a bias spring located between said valve portion and said valve cap for urging a distal end of said valve portion against said valve seat portion for retaining the valve portion in a closed position.

30. The apparatus of claim 28 wherein:
said valve operation handle includes a valve cap contacting end.

31. The apparatus of claim 30 wherein said valve cap contacting end is round.

32. The apparatus of claim 28 wherein said valve and actuator member and said sealing member are provided as a unified, integrated structure.

33. The apparatus of claim 28 wherein said valve operation handle is connected to said actuator portion by means of a pivoted handle-to-actuator connection.

34. The apparatus of claim 23 wherein said vent tube assembly includes:
a vent tube received in said vent-tube-reception channel, and
a vent tube air valve assembly connected to a distal end of said vent tube.

35. The apparatus of claim 34 wherein said vent tube air valve assembly includes:
an air valve housing which includes one or more vent holes,
a sealing ring fixed onto said vent tube between said vent tube and said air valve housing, and
a one-way valve element connected to said air valve housing for covering said one or more vent holes.

36. The apparatus of claim 23 wherein:
said top bracket portion includes top-to-riser connectors,
said riser bracket portion includes riser-to-top connectors and riser-to-bottom connectors, wherein said riser-to-top connectors engage said top-to-riser connectors, and
said bottom bracket portion includes bottom-to-riser connectors which engage said riser-to-bottom connectors.

37. The apparatus of claim 36 wherein:
said riser-to-bottom connectors include locking barbs, and
said botfom-to-riser connectors include locking-barb reception surfaces that engage with said locking barbs.

38. An inverted bottle support and dispenser apparatus, comprising:
a combination dispensing valve and vent tube unit for connecting to a bottle, and
a combination support unit for supporting said combination dispensing valve and vent tube unit,
wherein said combination support unit includes a top bracket portion for receiving said combination dispensing valve and vent tube unit, a riser bracket portion connected to said top bracket portion and descending downward therefrom, and a bottom bracket portion connected to a bottom end of said riser bracket portion,
wherein said riser bracket portion includes riser first side connectors located on one side of said riser bracket portion and complementary riser second side connectors located on an opposite side of said riser bracket portion, wherein said riser first side connectors of one riser bracket portion engage with said complementary riser second side connectors of an adjacent riser bracket portion when a plurality of apparatuses are used together.

39. The apparatus of claim 38 wherein:
said riser first side connectors are resilient female-like members, and
said riser second side connectors are male-like members.

40. An inverted bottle support and dispenser apparatus, comprising:
a combination dispensing valve and vent tube unit for connecting to a bottle, and
a combination support unit for supporting said combination dispensing valve and vent tube unit,
wherein said combination support unit includes a top bracket portion for receiving said combination dispensing valve and vent tube unit, a riser bracket portion connected to said top bracket portion and descending downward therefrom, and a bottom bracket portion connected to a bottom end of said riser bracket portion,
wherein said combination dispensing valve and vent tube unit includes:
a valve body which includes a support-unit-engagement portion for engaging said combination support unit, a bottle-reception inlet portion, a vent-tube-reception channel, a valve seat portion, a spout portion, and a valve-assembly-reception channel,
a vent tube assembly received in said vent-tube-reception channel,
a valve assembly, a portion of which is received in said valve-assembly-reception channel for retention inside said valve body, and
a valve cap removably connected to said valve body for retaining a portion of said valve assembly in said valve body and for permitting removal of said valve assembly from said valve body,
wherein said support-unit-engagement portion includes inner wall portions and outer flange portions, wherein said inner wall portions include opposed flat inner wall portions and opposed round inner wall portions,
wherein said top bracket portion includes opposed flat inner wall portions and a round inner wall portion,
wherein said opposed flat inner wall portions of said top bracket portion are separated from each other by a first separation distance, and wherein said round inner wall portion has an internal diameter which is greater than said first separation distance, and
wherein said opposed round inner wall portions are separated from each other by a second separation distance which is greater than said first separation distance.

41. The apparatus of claim 40 wherein said internal diameter of said round inner wall portion and said second separation distance of said opposed round inner wall portions are substantially equal.
